(19) United States
(12) Patent Application Publication
(10) Pub. No.: US 2016/0014571 A1
(43) Pub. Date: Jan. 14, 2016

(54) ENHANCED EMBMS INTEREST INDICATION

(71) Applicant: QUALCOMM Incorporated, San Diego, CA (US)

(72) Inventors: Kuo-Chun LEE, San Diego, CA (US); Daniel AMERGA, San Diego, CA (US); Shailesh MAHESHWARI, San Diego, CA (US); Muralidharan MURUGAN, San Diego, CA (US); Jack Shyh-Hurng SHAUH, San Diego, CA (US); Sivaramakrishna VEEREPALLI, San Diego, CA (US); Jun WANG, Poway, CA (US); Xiaoxia ZHANG, San Diego, CA (US)

(21) Appl. No.: 14/327,414

(22) Filed: Jul. 9, 2014

(51) Int. Cl. H04W 4/06

(52) U.S. Cl. CPC H04W 4/06; H04L 12/189

(57) ABSTRACT

A method, an apparatus, and a computer program product for wireless communication are provided. The apparatus sends a message including an indication of at least one frequency of interest and at least one alternative frequency of interest. In an aspect, the at least one frequency of interest is used to provide a set of multimedia broadcast multicast service (MBMS) services and the at least one alternative frequency of interest is used to provide a subset of MBMS services of the set of MBMS services. The apparatus receives, for each MBMS service in the set of MBMS services, said each MBMS service using one of the at least one frequency of interest or the at least one alternative frequency of interest based on the message.

### BACKGROUND

1. Field

The present disclosure relates generally to communication systems, and more particularly, to Multimedia Broadcast Multicast Service (MBMS).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus sends a message including an indication of at least one frequency of interest and at least one alternative frequency of interest. In an aspect, the at least one frequency of interest is used to provide a set of MBMS services and the at least one alternative frequency of interest is used to provide a subset of MBMS services of the set of MBMS services. The apparatus receives, for each MBMS service in the set of MBMS services, said each MBMS service using one of the at least one frequency of interest or the at least one alternative frequency of interest based on the message.

In another aspect, the apparatus includes a memory and at least one processor coupled to the memory. The at least one processor is configured to send a message including an indication of at least one frequency of interest and at least one alternative frequency of interest. In an aspect, the at least one frequency of interest is used to provide a set of MBMS services and the at least one alternative frequency of interest is used to provide a subset of MBMS services of the set of MBMS services. The at least one processor is further configured to receive, for each MBMS service in the set of MBMS services, said each MBMS service using one of the at least one frequency of interest or the at least one alternative frequency of interest based on the message.

In another aspect, the apparatus includes means for sending a message including an indication of at least one frequency of interest and at least one alternative frequency of interest. In an aspect, the at least one frequency of interest is used to provide a set of MBMS services and the at least one alternative frequency of interest is used to provide a subset of MBMS services of the set of MBMS services. The apparatus further includes means for receiving, for each MBMS service in the set of MBMS services, said each MBMS service using one of the at least one frequency of interest or the at least one alternative frequency of interest based on the message.

In another aspect, the computer program product stored on a computer-readable medium and comprising code that when executed on at least one processor causes the at least one processor to send a message including an indication of at least one frequency of interest and at least one alternative frequency of interest. In an aspect, the at least one frequency of interest is used to provide a set of MBMS services and the at least one alternative frequency of interest is used to provide a subset of MBMS services of the set of MBMS services. The code when executed on at least one processor further causes the at least one processor to receive, for each MBMS service in the set of MBMS services, said each MBMS service using one of the at least one frequency of interest or the at least one alternative frequency of interest based on the message.

In another aspect of the disclosure, a method, a computer program product, and an apparatus are provided. The apparatus receives, from a user equipment (UE), a message including an indication of at least one frequency of interest and at least one alternative frequency of interest. In an aspect, a set of MBMS services are provided on the at least one frequency of interest and a subset of MBMS services of the set of MBMS services are provided on the at least one alternative frequency of interest. The apparatus determines, for each MBMS service in the set of MBMS services, whether the UE is to receive said each MBMS service using one of the at least one frequency of interest or the at least one alternative frequency of interest based on the message. The apparatus establishes or maintains a connection with the UE using each of said one of the at least one frequency of interest or the at least one alternative frequency of interest based on the determination.

In another aspect, the apparatus includes a memory and at least one processor coupled to the memory. The at least one processor is configured to receive, from a UE, a message including an indication of at least one frequency of interest and at least one alternative frequency of interest. In an aspect, a set of MBMS services are provided on the at least one frequency of interest and a subset of MBMS services of the set of MBMS services are provided on the at least one alternative frequency of interest. The at least one processor is further configured to determine, for each MBMS service in the set of MBMS services, whether the UE is to receive said each MBMS service using one of the at least one frequency of interest or the at least one alternative frequency of interest based on the message. The at least one processor is further configured to establish or maintain a connection with the UE using each of said one of the at least one frequency of interest or the at least one alternative frequency of interest based on the determination.

In another aspect, the apparatus includes means for receiving, from a UE, a message including an indication of at least one frequency of interest and at least one alternative frequency of interest. In an aspect, a set of MBMS services are provided on the at least one frequency of interest and a subset of MBMS services of the set of MBMS services are provided on the at least one alternative frequency of interest. The apparatus further includes means for determining, for each MBMS service in the set of MBMS services, whether the UE is to receive said each MBMS service using one of the at least one frequency of interest or the at least one alternative frequency of interest based on the message. The apparatus further includes means for establishing or maintaining a connection with the UE using each of said one of the at least one frequency of interest or the at least one alternative frequency of interest based on the determination.

In another aspect, the computer program product stored on a computer-readable medium and comprising code that when executed on at least one processor causes the at least one processor to receive, from a UE, a message including an indication of at least one frequency of interest and at least one alternative frequency of interest. In an aspect, a set of MBMS services are provided on the at least one frequency of interest and a subset of MBMS services of the set of MBMS services are provided on the at least one alternative frequency of interest. The code when executed on at least one processor further causes the at least one processor to determine, for each MBMS service in the set of MBMS services, whether the UE is to receive said each MBMS service using one of the at least one frequency of interest or the at least one alternative frequency of interest based on the message. The code when executed on at least one processor further causes the at least one processor to establish or maintain a connection with the UE using each of said one of the at least one frequency of interest or the at least one alternative frequency of interest based on the determination.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information Media Access Control control element.

FIGS. 8A and 8B are example diagrams illustrating uses of an MBMS Interest Indication message.

FIG. 9 is an example information element (IE) structure for an MBMS Interest Indication message.

FIG. 10 is an example diagram illustrating use of an MBMS Interest Indication, according to the disclosure.

FIG. 11 is an example IE structure for an MBMS Interest Indication message according to an aspect of the disclosure.

FIG. 12A is a flow chart of a method of wireless communication, according to an aspect of the disclosure.

FIG. 12B is a flow chart of a method of wireless communication, according to an aspect of the disclosure.

FIG. 13 is a flow chart of a method of wireless communication, expanding from the flow chart of FIG. 12A or the flow chart of FIG. 12B.

FIG. 14 is a conceptual data flow diagram illustrating the data flow between different modules/means/components in an exemplary apparatus.

FIG. 15 is a diagram illustrating an example of a hardware implementation for an apparatus employing a processing system.

FIG. 16 is a flow chart of a method of wireless communication, according to an aspect of the disclosure.

FIG. 17 is a conceptual data flow diagram illustrating the data flow between different modules/means/components in an exemplary apparatus.

FIG. 18 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

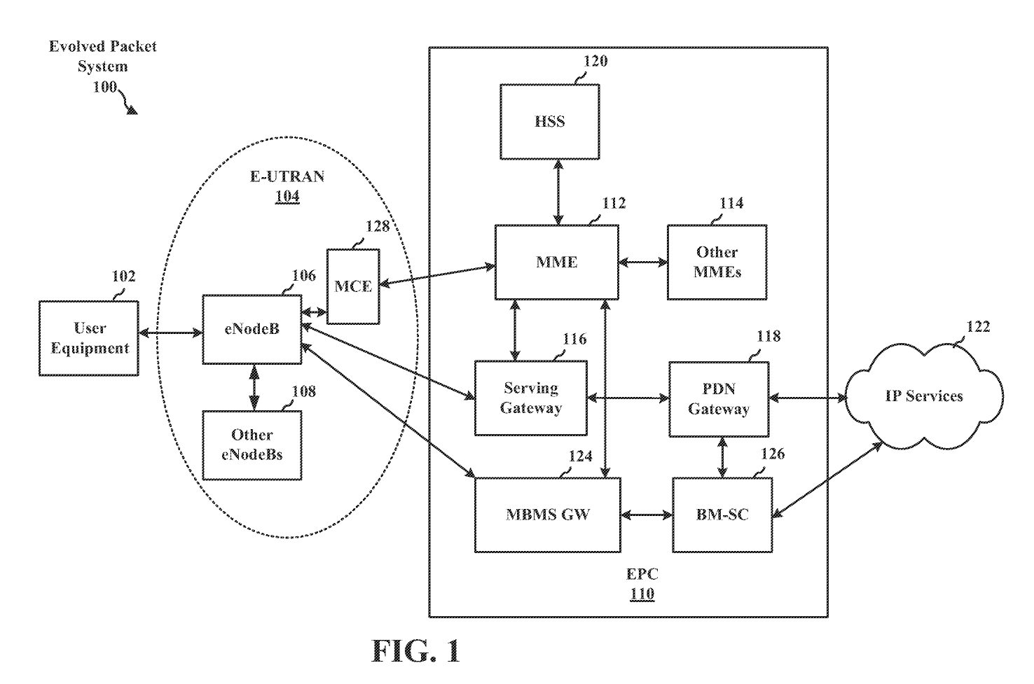

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

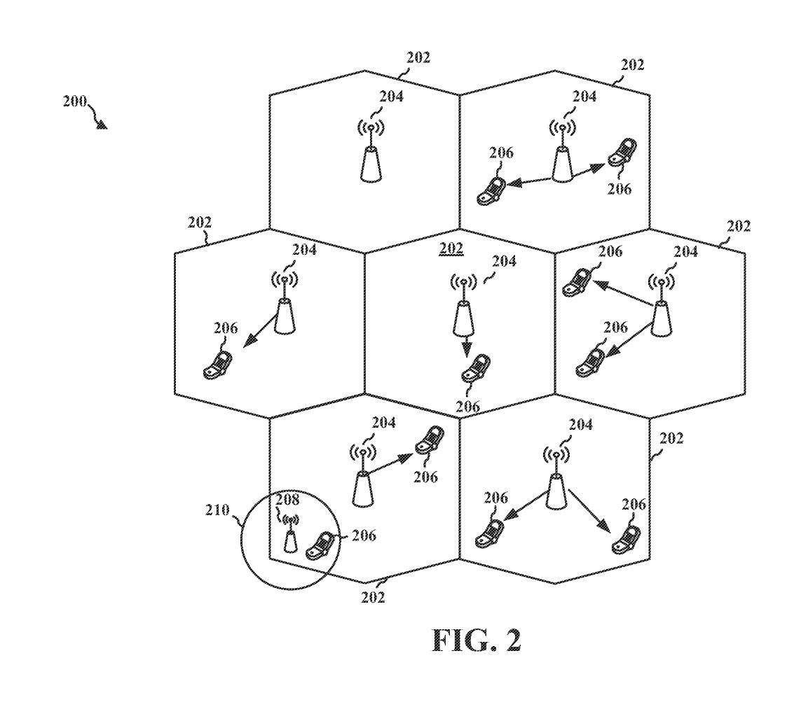

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

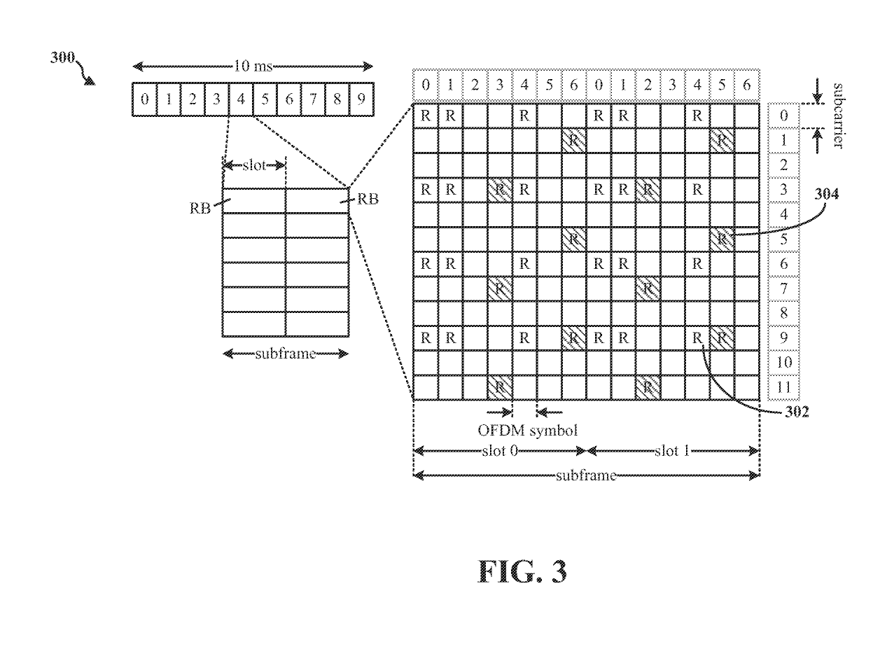

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

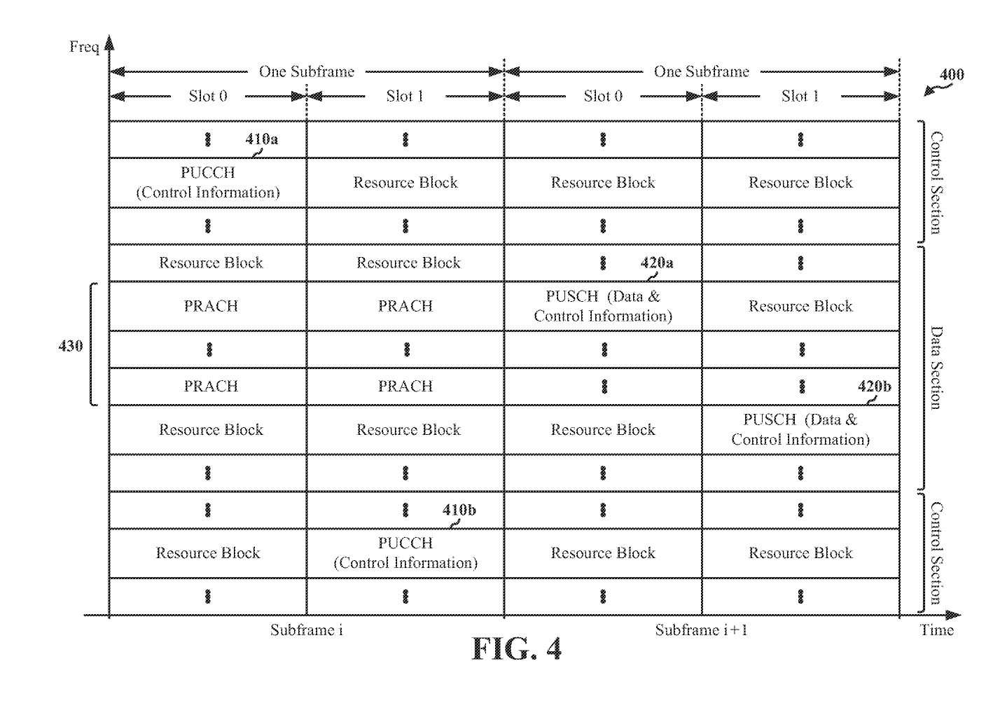

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

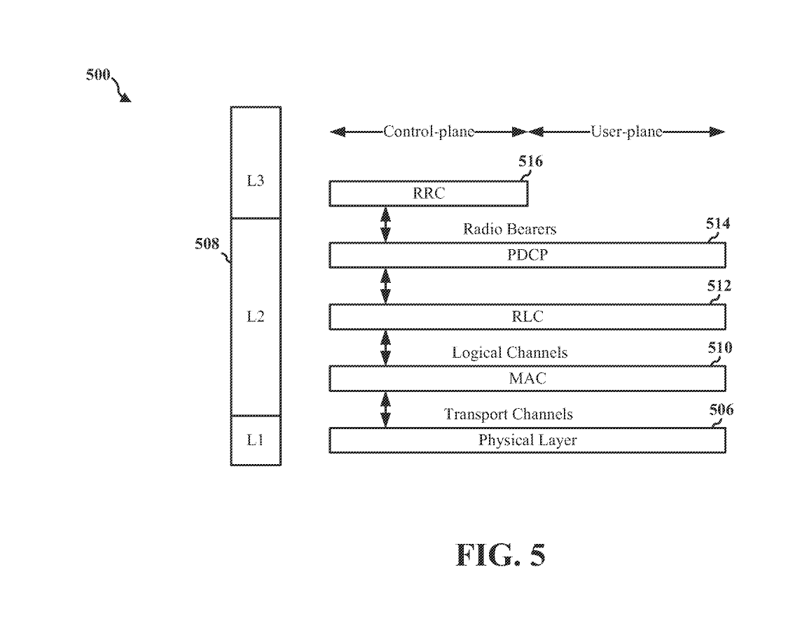

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

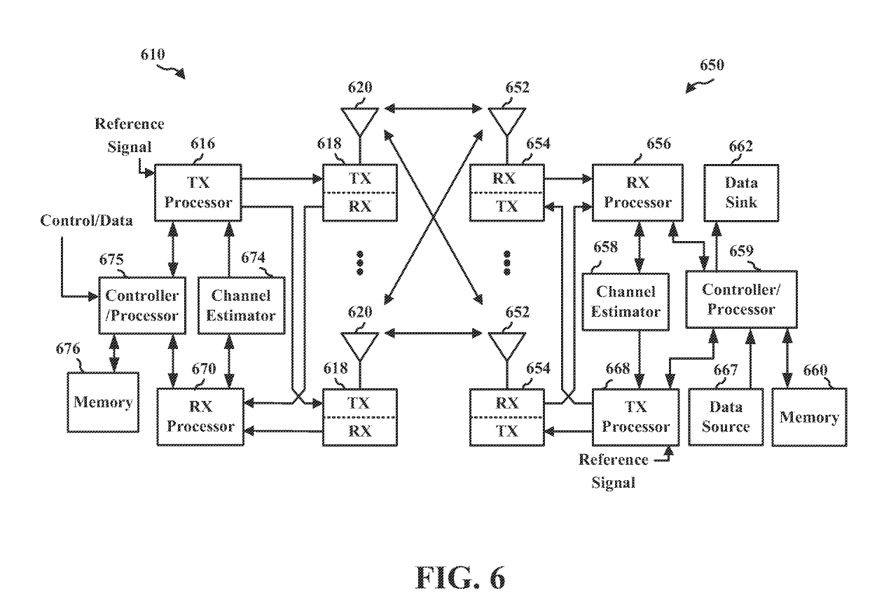

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

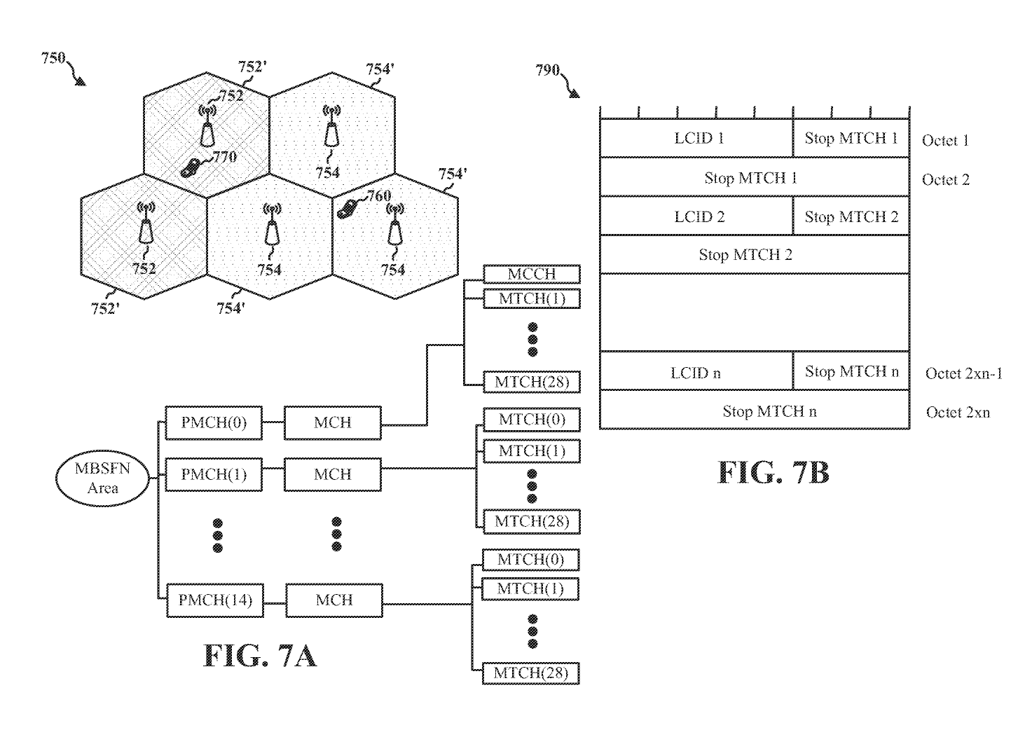

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE may acquire a system information block (SIB) 13 (SIB13). In a second step, based on the SIB13, the UE may acquire an MBSFN Area Configuration message on an MCCH. In a third step, based on the MBSFN Area Configuration message, the UE may acquire an MCH scheduling information (MSI) MAC control element. The SIB13 may indicate (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

In multiband deployment, a connected mode UE (a UE in an RRC connected state) may send an MBMS Interest Indication message to a network, where the MBMS Interest Indication indicates a frequency of interest for the UE. In an aspect, if a user of the UE attempts to select one or more MBMS services (e.g., a news service, a sports service, etc.) using the UE, frequencies associated with such MBMS services may be frequencies of interest. For example, if a UE camped on a first frequency (F1) is interested in receiving an MBMS service using a second frequency (F2), the UE may send an MBMS Interest Indication message to an eNB to indicate F2 as a frequency of interest. After receiving the MBMS Interest Indication message from the UE, the eNB may cause the UE to handover to F2 in order to enable the UE to receive an eMBMS service on F2. In another example, a UE may send an MBMS Interest Indication message indicating multiple frequencies of interest to an eNB, where the UE may attempt to simultaneously receive multiple MBMS services on the multiple frequencies respectively. Subsequently, the eNB can handover the UE to the multiple frequencies indicated in the MBMS Interest Indication message, such that the UE may receive the multiple MBMS services on the multiple frequencies simultaneously. In such an example, among multiple cells respectively having the multiple frequencies, a cell with one frequency is considered a primary cell (PCell) and other remaining cells with other respective frequencies are considered secondary cell (SCells). In one example, a PCell may provide a first service via one frequency and an SCell may provide a second service via another frequency. In another example, a PCell may provide a service via one frequency and an SCell may provide a duplicate of the same service via another frequency. It is noted that carriers corresponding to the PCell and carriers corresponding to the SCell may be aggregated (e.g., via carrier aggregation).

It is noted that the UE may determine a frequency of interest from a SIB15 and/or a USD. The SIB15 includes a list of neighboring frequencies and a current frequency, where each frequency in the list includes a list of MBMS service area identities (SAIs) supported by a respective frequency. The USD includes TMGIs corresponding to respective MBMS services and MBMS SAIs, and further includes information on association between the TMGIs and the MBMS SAIs. Thus, in one aspect, for one or more MBMS services of interest, the UE may use information from the SIB15 and the USD to determine the MBMS SAIs associated with the corresponding TMGI(s) of interest, and then may determine the frequency(ies) associated with the MBMS SAIs as the frequency(ies) of interest.

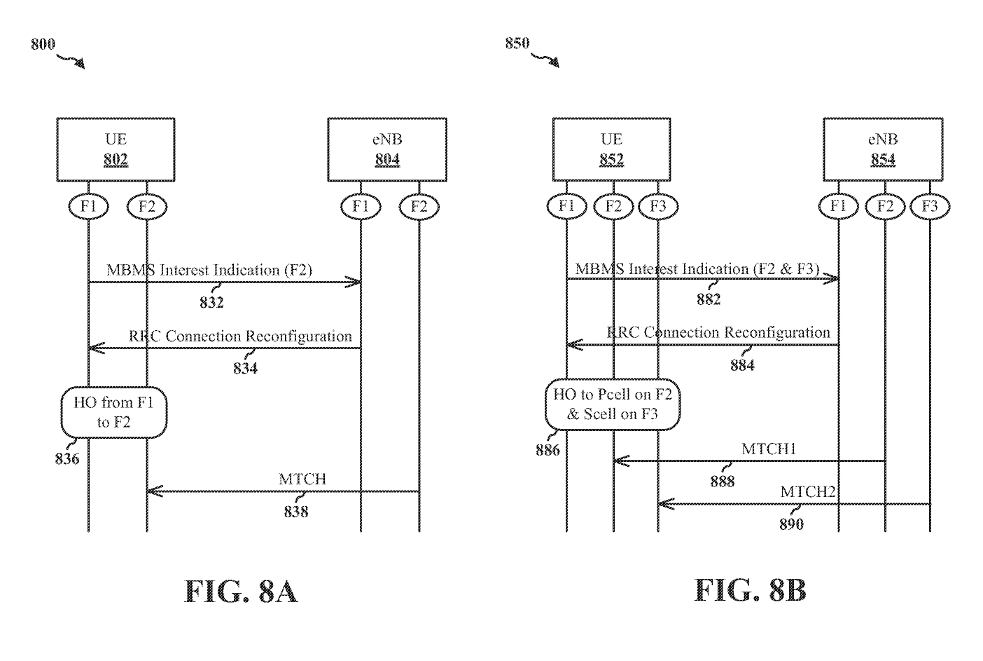

FIGS. 8A and 8B are example diagrams illustrating uses of an MBMS Interest Indication message. FIG. 8A is an example diagram 800 where an MBMS Interest Indication for a single frequency is communicated. The example diagram 800 illustrates communication between an UE 802 and an eNB 804. The UE 802 is initially camped on F1 of the eNB 804. If the UE 802 is interested in receiving an MBMS service using F2 of the eNB 804, the UE 802 generates and sends at 832 an MBMS Interest Indication message indicating F2 as a frequency of interest to a cell utilizing F1 in the eNB 804. In response, the cell utilizing F1 in the eNB 804 sends at 834 an RRC connection reconfiguration message to the UE 802. After receiving the RRC connection reconfiguration message, the UE 802 performs at 836 a handover from the cell utilizing F1 to a cell utilizing F2. After the handover, the UE 802 receives at 838 an MTCH from the cell utilizing F2 in the eNB 804, in order to receive a service on F2. FIG. 8B is an example diagram 850 where an MBMS Interest Indication for two frequencies is communicated. The example diagram 850 illustrates communication between an UE 852 and an eNB 854. The UE 852 is initially camped on F1. If the UE 802 is interested in receiving MBMS services using F2 and a third frequency (F3), the UE 852 generates and sends at 882 an MBMS Interest Indication message indicating F2 and F3 as frequencies of interest to a cell utilizing F1 in the eNB 854. In response, the cell utilizing F1 in the eNB 854 sends at 884 an RRC connection reconfiguration message to the UE 852. After receiving the RRC connection reconfiguration message, the UE 852 performs at 886 a handover from the cell utilizing F1 to a PCell utilizing F2 and an SCell utilizing F3 in the eNB 804. After the handover, the UE receives at 888 a first MTCH (MTCH1) from the PCell utilizing F2 in the eNB 804 in order to receive a service on F2, and receives at 890 a second MTCH (MTCH2) from the SCell utilizing F3 in the eNB 804 in order to receive a service on F3.

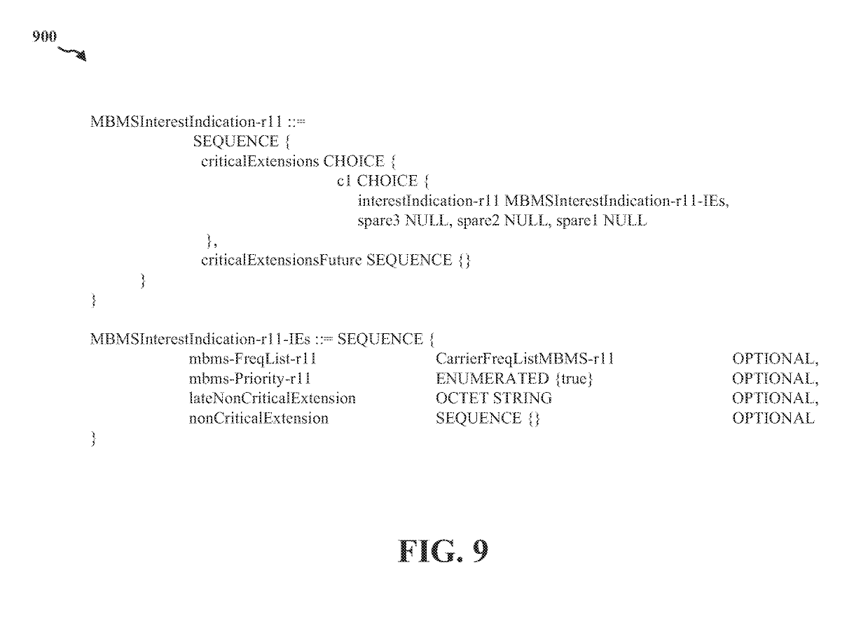

FIG. 9 is an example information element (IE) structure 900 for an MBMS Interest Indication message. As discussed supra, the MBMS Interest Indication message may be communicated from a UE to an eNB. According to the example IE structure of FIG. 9, an MBMS Interest Indication may be included in an IE “MBMSInterestIndication-r11-IEs.” According to the example IE structure of FIG. 9, a main frequency list “mbms-FreqList-r11” includes one or more frequencies of interest in a parameter “CarrierFreqListMBMS-r11” associated with “MBMSInterestIndication-r11-IEs.” If multiple frequencies exist in “mbms-FreqList-r11,” the UE is interested in receiving MBMS services simultaneously from the multiple frequencies. Presence of “mbms-Priority-r11” indicates that an MBMS service has a higher priority than a unicast service. On the contrary, absence of “mbms-Priority-r11” indicates that a unicast service has a higher priority than an MBMS service. For example, if “mbms-Priority-r11” is not present in the IE structure and the UE detects both MBMS cells and unicast cells, then an eNB may not cause the UE to handover to an MBMS cell and attempt to stay on one of the unicast cells, due to the higher priority on a unicast service than on an MBMS service.

As discussed supra, an MBMS service of interest may be available on multiple frequencies, for example, due to content duplication of the MBMS service for the multiple frequencies. In one case, the UE may have interest in an MBMS service, where the cell utilizing F2 and the cell utilizing F3 may broadcast the same MBMS service (e.g., due to content duplication). In such a case, according to the example discussed supra in association with FIG. 9, the MBMS Interest Indication message generally can list only one of F2 and F3 when the cell utilizing F2 and the cell utilizing F3 broadcast the same MBMS service. Therefore, there is a demand for an approach to list multiple frequencies in the MBMS Interest Indication message when the same MBMS service is provided on the multiple frequencies. In another case, the UE may have interest in multiple MBMS services. For example, the UE may have interest in MBMS service 1 (e.g., a news service) and MBMS service 2 (e.g., a sports service), where the cell utilizing F2 may broadcast MBMS service 1 and the cell utilizing F3 may broadcast MBMS service 2. In such a case, when multiple frequencies are listed in the MBMS Interest Indication message, the MBMS Interest Indication message generally does not specify which frequency should be used to receive a service, and thus the UE generally receives services corresponding to the multiple frequencies simultaneously. Therefore, according to the example discussed supra in association with FIG. 9, when the MBMS Interest Indication message lists F2 for a first service and F3 for a second service, the UE receives the first service on F2 and the second service on F3 simultaneously, but cannot determine to receive one of the services on F2 and F3 based on the MBMS Interest Indication message. Accordingly, there is a demand for an approach to selectively utilize one or more of multiple frequencies of interest listed in the MBMS Interest Indication message.

In another case, the UE may be interested in receiving multiple services from multiple frequencies (e.g., simultaneously). For example, the UE may be interested in receiving a sports service on one frequency and a news service on another frequency simultaneously. In such a case, multiple MBMS services may be provided on one set of multiple frequencies, and may also be provided on another set of multiple frequencies. For example, if MBMS service 1 is provided on F2 and a fourth frequency (F4), and MBMS service 2 may be provided on F3 and a fifth frequency (F5), MBMS service 1 and MBMS service 2 may be provided on a first set of frequencies {F2, F3} and may also be provided on a second set of frequencies {F4, F5}. Thus, in such an example, the second set of frequencies {F4 and F5} may be considered an alternative set of frequencies for the first set of frequencies {F2 and F3} to receive MBMS service 1 and MBMS service 2. Therefore, it may be desirable to include a set of frequencies and one or more alternative sets of frequencies in the MBMS Interest Indication message to receive MBMS services. In one example, it may be desirable to have the MBMS Interest Indication message include alternative frequencies for MBMS services in an unlicensed spectrum.

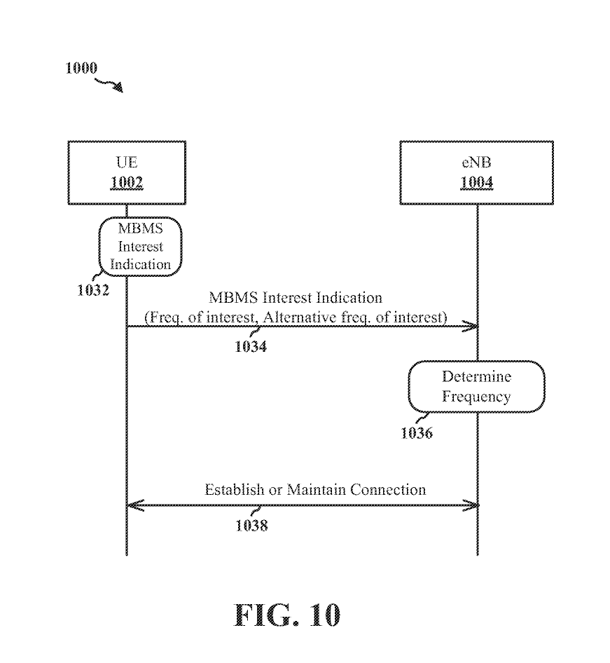

According to the disclosure, a UE generates and sends an MBMS Interest Indication message that lists one or more frequencies of interest for a set of MBMS services and one or more alternative frequencies of interest for a subset of the set of the MBMS services, such that an eNB may determine one or more frequencies on which the UE is to receive one or more MBMS services based on the MBMS Interest Indication message. For example, the MBMS Interest Indication message may list frequencies for MBMS service 1, MBMS service 2, and MBMS service 3, and may also list alternative frequencies for all or some of MBMS service 1, MBMS service 2, and MBMS service 3. FIG. 10 is an example diagram 1000 is an example diagram illustrating use of an MBMS Interest Indication message, according to the disclosure. The example diagram 1000 illustrates communication between a UE 1002 and an eNB 1004. At 1032, the UE 1002 generates an MBMS Interest Indication message listing at least one frequency of interest and at least one alternative frequency of interest. At 1034, the UE 1002 sends the MBMS Interest Indication message to the eNB 1004. At 1036, the eNB 1004 determines a frequency on which the UE 1002 should receive an MBMS service, among at least one frequency of interest and at least one alternative frequency of interest. At 1038, if the determined frequency is the current frequency on which the UE 1002 is currently camped, the UE 1002 maintains a connection with a current frequency. At 1038, if the determined frequency is not the current frequency on which the UE 1002 is currently camped, the UE 1002 performs a handover from the current frequency to the determined frequency, to receive the MBMS service on the determined frequency. Various aspects of the disclosure are discussed infra.

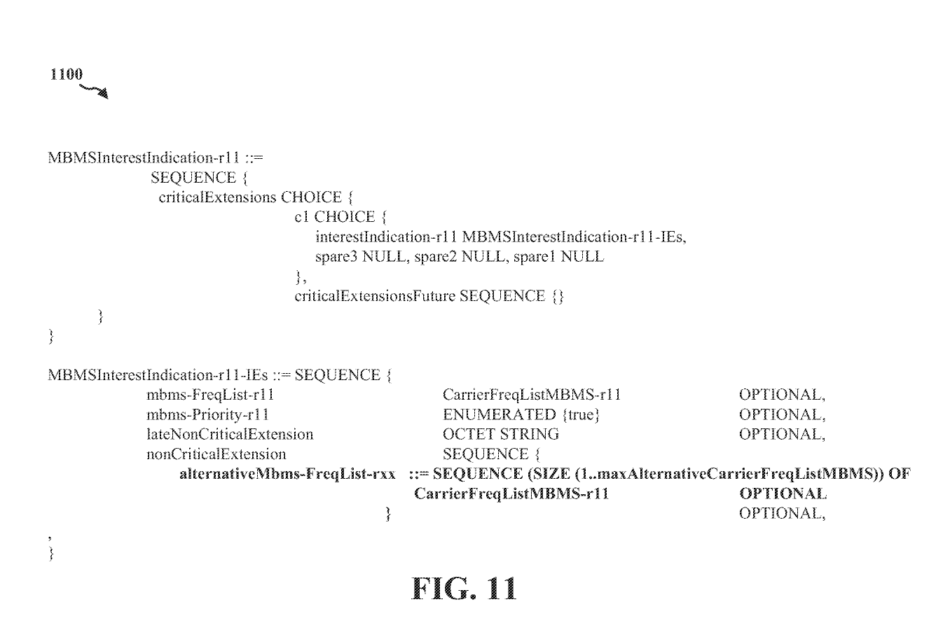

According an aspect of the disclosure, an MBMS Interest Indication message communicated from the UE to the eNB includes an alternative frequency list to list one or more alternative frequencies of interest, in addition to a main frequency list to list one or more frequencies of interest. Thus, the MBMS Interest Indication message according to such an aspect of the disclosure may include an IE for a main frequency list and a new IE for an alternative frequency list. FIG. 11 is an example IE structure 1100 for an MBMS Interest Indication message according to an aspect of the disclosure. It is noted that the example IE structure 1100 of FIG. 11 is different from the example IE structure 900 of FIG. 9 at least in a portion with letters in bold. As discussed supra, the MBMS Interest Indication message may be communicated from a UE to an eNB. According to the example IE structure of FIG. 11, the MBMS Interest Indication message includes a main frequency list “mbms-FreqList-r11” including one or more frequencies of interest in a parameter “CarrierFreqListMBMS-r11” associated with “MBMSInterestIndication-r11-IEs.” In the example IE structure of FIG. 11, the MBMS Interest Indication message includes an alternative frequency list “alternativeMbms-FreqList” having one or more parameters “CarrierFreqListMBMS” to list one or more alternative frequencies of interest. Thus, for example, if the UE determines that the same MBMS service may be provided on two frequencies, the UE lists one frequency in “mbms-FreqList-r11” and lists the other frequency in “alternativeMbms-FreqList.” According to one approach, the UE may list a frequency with a better signal quality (e.g., a higher RSRP/RSRQ value) in the main frequency list “mbms-FreqList-r11,” while listing other frequency(ies) in the alternative frequency list “alternativeMbms-FreqList.” According to another approach, the UE may arbitrarily list frequencies in “mbms-FreqList-r11” and “alternativeMbms-FreqList.” As discussed supra, the UE may determine the frequencies of interest by reading the SIB15 and/or the USD.

For example, referring to the example IE structure of FIG. 11, in a case where the UE receives an MBMS service on a single frequency, the main frequency list “mbms-FreqList-r11” may include the parameter “CarrierFreqListMBMS” to list F2 for MBMS service 1 and the alternative frequency list “alternativeMbms-FreqList” may include the parameter “CarrierFreqListMBMS” to list F3 for MBMS service 1. Upon receiving the MBMS Indication Interest message, the eNB may determine whether the UE should receive the MBMS service 1 on F2 or F3, and may cause the UE to receive MBMS service 1 on the determined frequency. In another example, in a case where the UE receives MBMS services on multiple frequencies, the main frequency list “mbms-FreqList-r11” may include the parameter “CarrierFreqListMBMS” to list F2 for MBMS service 1 and F3 for MBMS service 2, and the alternative frequency list “alternativeMbms-FreqList” may include the parameter “CarrierFreqListMBMS” to list F4 for MBMS service 1 and F5 for MBMS service 2. In such an example, upon receiving the MBMS Indication Interest message, the eNB may determine whether the UE should receive the MBMS service 1 and MBMS service 2 on a set {F2 and F3} or a set {F4 and F5}, and may cause the UE to receive the MBMS service 1 and MBMS service 2 on the determined set of frequencies.

In another aspect of the disclosure, the UE may generate the MBMS Interest Indication message such that the main frequency list in the MBMS Interest Indication message may list one or more frequencies of interest with an implicit priority over frequencies listed in the alternative frequency list. The UE may determine the priority based on the RSRP/RSRQ measurement on the frequencies. The RSRP/RSRQ measurement may be based on at least one of a unicast RSRP measurement, a unicast RSRQ measurement, an MBSFN RSRP measurement, or an MBSFN RSRQ measurement. In an example, the UE may list one or more frequencies with higher priorities (e.g., higher RSRP/RSRQ measurements) in the main frequency list, and may list one or more frequencies with lower priorities (e.g., lower RSRP/RSRQ measurements) in the alternative frequency list. Referring back to the example in FIG. 11, in an aspect, the main frequency list “mbms-FreqList-r11” may list one or more frequencies of interest with an implicit priority over frequencies listed in the alternative frequency list “alternativeMbms-FreqList.” In an aspect, if multiple frequencies are to be listed in the alternative frequency list in the MBMS Interest Indication message, the UE lists the multiple frequencies in the alternative frequency list according to an order of priority. For example, the multiple frequencies listed in the alternative frequency list may be listed in an order based on RSRP/RSRQ values of the frequencies.

In one example, referring to the example IE structure of FIG. 11, the main frequency list “mbms-FreqList-r11” may list F2 and the alternative frequency list “alternativeMbms-FreqList” may list F4 and a sixth frequency (F6), where the UE may receive the same MBMS service using any one of F2, F4 and F6. In such an example, according to an aspect of the disclosure, F2 in the main frequency list “mbms-FreqList-r11” has a higher priority than F4 and F6 that are listed in “alternativeMbms-FreqList.” In such an example, F4 has a higher priority than F6 because F4 is listed before F6 in “alternativeMbms-FreqList.” Thus, in such an example, the UE prefers utilizing F2 to receive the MBMS service over using F4 or F6, and prefers using F4 to receive the MBMS service over using F6. In another example, the main frequency list “mbms-FreqList-r11” may list F2 and F3 and the alternative frequency list “alternativeMbms-FreqList” may list F4, F5, F6, and a seventh frequency (F7), where the UE may receive a first MBMS service using any one of F2, F4 and F6 and may receive a second MBMS service using any one of F3, F5 and F7. The UE may receive the first MBMS service and the second MBMS service simultaneously using a first set of frequencies {F2, F3} or a second set of frequencies {F4, F5} or a third set of frequencies {F6, F7}. In such an example, according to an aspect of the disclosure, the first set of frequencies {F2, F3} in the main frequency list “mbms-FreqList-r11” has a higher priority than the second set of frequencies {F4, F5} or the third set of frequencies {F6, F7} that are listed in the alternative frequency list “alternativeMbms-FreqList.” In such an example, the second set of frequencies {F4, F5} has a higher priority than the third set of frequencies {F6, F7} because the second set of frequencies {F4, F5} is listed before the third set of frequencies {F6, F7} in the alternative frequency list “alternativeMbms-FreqList.”

In another aspect of the disclosure, the UE may generate the MBMS Interest Indication message such that the MBMS Interest Indication message includes a main frequency list that may list multiple frequencies. For example, regardless of whether the same MBMS service is provided on the multiple frequencies or different MBMS services are provided on the multiple frequencies, the main frequency list in the MBMS Interest Indication message may list the multiple frequencies. In such an aspect, the MBMS Interest Indication message may not include an alternative frequency list that is separate from the main frequency list. For example, use of the example information element (IE) structure 900 of the MBMS Interest Indication message may be modified without adding an alternative frequency list, such that the main frequency list “mbms-FreqList-r11” may include multiple frequencies, even if the same MBMS service is provided on the multiple frequencies. Thus, according to this aspect of the disclosure, for example, the MBMS Interest Indication message may carry the main frequency list “mbms-FreqList-r11” that lists multiple frequencies on which the same MBMS service is provided, and the UE may receive the MBMS service on one of the multiple frequencies. In another example, the MBMS Interest Indication message may carry the main frequency list “mbms-FreqList-r11” listing multiple frequencies providing different MBMS services, and the UE may receive the different MBMS services on multiple frequencies simultaneously.

For example, the UE that is currently receiving an MBMS service on F1 may determine that a first TMGI (TMGI1) is associated with F1 and F2 for the same MBMS service, and a second TMGI (TMGI2) is associated with an eighth frequency (F8) on which no MBMS service is provided. Subsequently, the UE sends an MBMS Interest Indication message with a main frequency list listing F1 and F2, but not F8. When the eNB receives the MBMS Interest Indication, the eNB determines the content duplication in F1 and F2 because F1 and F2 provide the same MBMS service (e.g., according to the association of F1 and F2 with the TMGI1). The eNB selects one of F1 and F2 for the UE to receive the MBMS service based on signal strength (e.g., RSRP/RSRQ measurement) of F1 and F2. Thus, the eNB may determine whether to cause the UE to hand off from F1 to F2 based on the signal strength (e.g., RSRP/RSRQ measurement) of F1 and F2. For example, if F2's signal strength is higher than F1's signal strength, it may be desirable to perform the UE handover from F1 to F2, in order to receive the same MBMS service on F2 that provides better signal strength than F1. On the contrary, if F1's signal strength is higher than F2's signal strength, it may be desirable for the UE to stay on F1 to receive the same MBMS service on F1, without a handover. It is noted that the eNB receives a measurement report on the signal strength of F1 and F2 from the UE to determine the signal strength of F1 and F2 at the UE. The measurement report may include the RSRP/RSRQ measurements on F1 and F2, where the RSRP/RSRQ measurements may be based on at least one of a unicast RSRP measurement, a unicast RSRQ measurement, an MBSFN RSRP measurement, or an MBSFN RSRQ measurement.

In one aspect, if multiple frequencies are available for the same MBMS service, the UE may determine signal strengths of the multiple frequencies, and may list in the MBMS Interest Indication message frequencies that are greater than a minimum signal strength threshold. For example, the UE may detect F2, F3, F4, F5, F6, and F7, where MBMS service 1 is provided 1 F2, F4, and F6 and MBMS service 2 is provided on F3, F5, and F7. In such an example, if the signal strengths for F2, F3, F6, and F7 are greater than a minimum signal strength threshold, and the signal strengths for F4 and F5 are less than the minimum signal strength threshold, the UE may list F2 and F3 as main frequencies and may list F6 and F7 as alternative frequencies in the MBMS Interest Indication message, while not listing F4 and F5 in the MBMS Interest Indication message. The UE may determine the signal strength of the multiple frequencies based on at least one of a unicast RSRP measurement, a unicast RSRQ measurement, an MBSFN RSRP measurement, or an MBSFN RSRQ measurement.

In another aspect, if multiple frequencies are available for the same MBMS service and if a signal strength of one frequency is significantly higher (e.g., based on a signal strength difference threshold) than the other frequencies, the UE may include in the MBMS Interest Indication message one of the multiple frequencies whose signal strength is significantly higher than the other frequencies. In one example, if the signal strength of F1 is higher than the signal strength of F2, and the difference in the signal strength between F1 and F2 is equal to or greater than the signal strength difference threshold, the UE may include F1 in the MBMS Interest Indication message and exclude F2 from the MBMS Interest Indication message. In another example, if the signal strength of F1 is higher than the signal strength of F2 but the difference in the signal strength between F1 and F2 is less than the signal strength difference threshold, the UE may include both F1 and F2 in the MBMS Interest Indication message. In such an example, after some time passes, if the signal strength of F2 becomes higher than the signal strength of F1 by the signal strength difference threshold or higher, a next MBMS Interest Indication message sent to the eNB will include F2, and will exclude F1.

In another aspect of the disclosure, the UE may list in a main frequency list of the MBMS Interest Indication message other frequencies on which the same MBMS service is provided as the current frequency if signal strength of MBMS service reception on the current frequency becomes weak (e.g., below a minimum signal strength threshold). In such an aspect, the MBMS Interest Indication message may not include an alternative frequency list. For example, use of the example IE structure 900 of the MBMS Interest Indication message may be modified such that the UE lists, in the MBMS Interest Indication message, one of other frequencies on which the same MBMS service is provided as the current frequency when signal strength of MBMS service reception on the current frequency falls below the minimum signal strength threshold. Because the UE lists in main frequency list of the MBMS Interest Indication message only one of multiple frequencies on which the same MBMS service is provided, if the UE determines that the signal strength on the current frequency is sufficiently strong (e.g., above a minimum signal strength threshold), the UE includes the current frequency in the MBMS Interest Indication message, and subsequently stays on the current frequency to receive the MBMS service on the current frequency. If the UE determines that the signal strength on the current frequency is not sufficiently strong (e.g., below a minimum signal strength threshold), the UE includes another frequency in the MBMS Interest Indication message, and subsequently eNB causes the UE to handover from the current frequency to another frequency.

In one example, the same MBMS service may be provided on F1 and F2, and the UE currently receives the MBMS service on F1. In such an example, if the signal strength on F1 falls below a minimum signal strength threshold, the UE lists the F2 in the MBMS Interest Indication message to the eNB. Subsequently, the eNB determines whether unicast signal strength on F2 is good (e.g., above a minimum signal strength threshold), and the eNB causes the UE to hand over from F1 to F2 if the eNB determines that the unicast signal strength on F2 is good. In another example, if the signal strength on F1 stays above the minimum signal strength threshold, the UE list F1 in the MBMS Interest Indication message to the eNB, and thus the eNB maintains the UE on F1. In such an example, the UE may list F1 (the current frequency) but may not list F2 in the MBMS Interest Indication message as long as the signal strength on F1 stays above the minimum signal strength threshold, even if the signal strength on F2 increases to a value above the minimum signal strength threshold.

As discussed supra, the UE may generate and send an MBMS Interest Indication message to an eNB, where the MBMS Interest Indication message lists at least one main frequency in the main frequency list and at least one alternative frequency in the alternative frequency list or where the MBMS Interest Indication message lists at least one main frequency and at least one alternative frequency in the main frequency list. When the eNB receives the MBMS Interest Indication message, then the eNB may determine the best frequency on which the UE may receive the MBMS service, among the frequencies listed the MBMS Interest Indication message, such that the UE may receive the MBMS service on the determined best frequency. If the eNB determines that a current frequency (e.g., a main frequency) is the best frequency, the eNB allows the UE to continue to receive the service on the current frequency. On the contrary, if the eNB determines that another frequency (e.g., an alternative frequency) on which the same service may be provided is the best frequency (e.g., better than the current frequency), the eNB may cause the UE to hand over the connected mode UE to such frequency. The eNB may determine the best frequency for the UE to receive the MBMS service based on metrics such as a loading condition and/or a measurement report from the UE. For example, the eNB may consider a frequency with the least loading condition as the best frequency. For example, the UE may send the measurement report including the RSRP/RSRQ measurement of each frequency to the eNB. Subsequently, the eNB may determine that a frequency with the highest RSRP/RSRQ measurement is the best frequency based on the measurement report. The RSRP/RSRQ measurement may be based on at least one of a unicast RSRP measurement, a unicast RSRQ measurement, an MBSFN RSRP measurement, or an MBSFN RSRQ measurement.

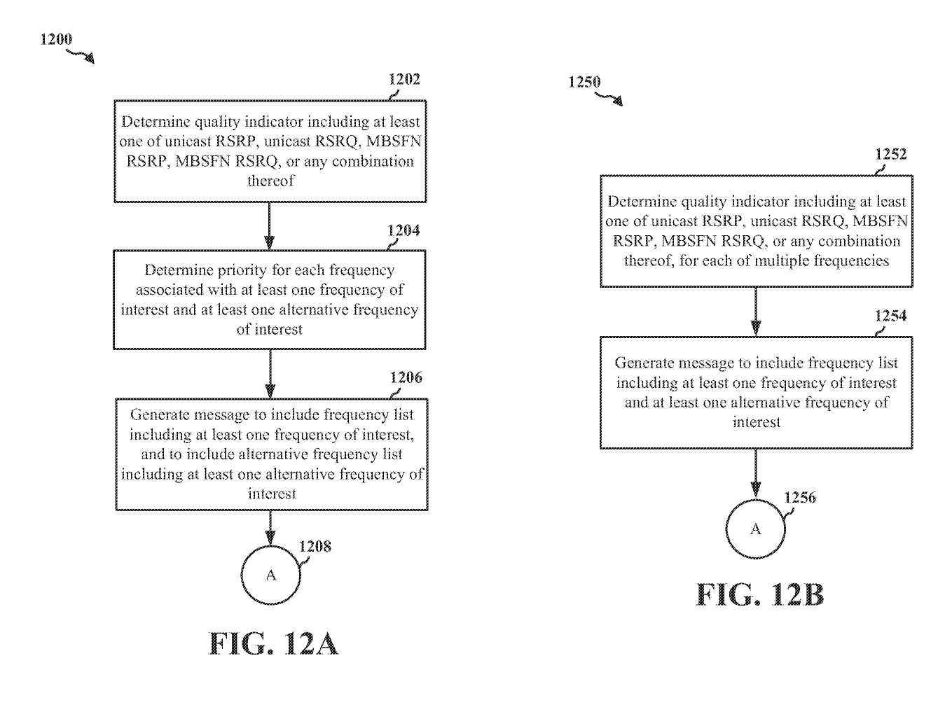

FIG. 12A is a flow chart 1200 of a method of wireless communication, according to an aspect of the disclosure. The method may be performed by a UE (e.g., the UE 1002, the apparatus 1402/1402′). At 1202, the UE determines a quality indicator including at least one of a unicast RSRP, a unicast RSRQ, an MBSFN RSRP, an MBSFN RSRQ, or any combination thereof. In an aspect, the UE may determine a quality indicator including at least one of a unicast RSRP, a unicast RSRQ, an MBSFN RSRP, an MBSFN RSRQ, or any combination thereof, for each of multiple frequencies. At 1204, the UE determines a priority for each frequency associated with the at least one frequency of interest and the at least one alternative frequency of interest. In an aspect, the frequency list includes at least one frequency for each MBMS service in the set of MBMS services with a highest determined priority, and the alternative frequency list includes at least one remaining frequency for each MBMS service in the subset of MBMS services. In an aspect, the alternative frequency list includes at least two alternative frequencies of interest in order of the determined priority. In an aspect, the priority is determined based on the determined quality indicator. At 1206, the UE generates a message to include a frequency list including the at least one frequency of interest, and to include an alternative frequency list including the at least one alternative frequency of interest. In an aspect, the at least one frequency of interest includes one or more frequencies of the plurality of frequencies with a corresponding determined quality indicator greater than a threshold, and the at least one alternative frequency of interest includes one or more alternative frequencies of the plurality of frequencies with a corresponding determined quality indicator greater than the threshold. At 1208, the UE performs additional features, such as the features described in FIG. 12 infra.

As discussed supra, the UE may generate the MBMS Interest Indication message such that the main frequency list in the MBMS Interest Indication message may list one or more frequencies of interest with an implicit priority over frequencies listed in the alternative frequency list. As discussed supra, if multiple frequencies are to be listed in the alternative frequency list in the MBMS Interest Indication message, the UE lists the multiple frequencies in the alternative frequency list according to an order of priority. As discussed supra, the UE may determine the priority based on the RSRP/RSRQ measurement that may be based on at least one of a unicast RSRP measurement, a unicast RSRQ measurement, an MBSFN RSRP measurement, or an MBSFN RSRQ measurement. As discussed supra, if multiple frequencies are available for the same MBMS service, the UE may determine signal strengths of the multiple frequencies, and may list in the MBMS Interest Indication message frequencies that are greater than a minimum signal strength threshold. As discussed supra, the UE may determine the signal strength of the multiple frequencies based on at least one of a unicast RSRP measurement, a unicast RSRQ measurement, an MBSFN RSRP measurement, or an MBSFN RSRQ measurement.

FIG. 12B is a flow chart 1250 of a method of wireless communication, according to an aspect of the disclosure. The method may be performed by a UE (e.g., the UE 1002 or the UE852, the apparatus 1402/1402′). At 1252, the UE may determine a quality indicator including at least one of a unicast RSRP, a unicast RSRQ, an MBSFN RSRP, an MBSFN RSRQ, or any combination thereof, for each of multiple frequencies. At 1254, the UE generates a message to include a frequency list including the at least one frequency of interest and the at least one alternative frequency of interest. In an aspect, the at least one frequency of interest includes one or more frequencies of the plurality of frequencies with a corresponding determined quality indicator greater than a threshold, and the at least one alternative frequency of interest includes one or more alternative frequencies of the plurality of frequencies with a corresponding determined quality indicator greater than the threshold. At 1256, the UE performs additional features, such as the features described in FIG. 12 infra.

As discussed supra, for example, the UE may generate the MBMS Interest Indication message such that the MBMS Interest Indication message includes a main frequency list that may list multiple frequencies. For example, as discussed supra, regardless of whether the same MBMS service is provided on the multiple frequencies or different MBMS services are provided on the multiple frequencies, the main frequency list in the MBMS Interest Indication message may list the multiple frequencies. As discussed supra, if multiple frequencies are available for the same MBMS service, the UE may determine signal strengths of the multiple frequencies, and may list in the MBMS Interest Indication message frequencies that are greater than a minimum signal strength threshold. As discussed supra, the UE may determine the signal strength of the multiple frequencies based on at least one of a unicast RSRP measurement, a unicast RSRQ measurement, an MBSFN RSRP measurement, or an MBSFN RSRQ measurement.

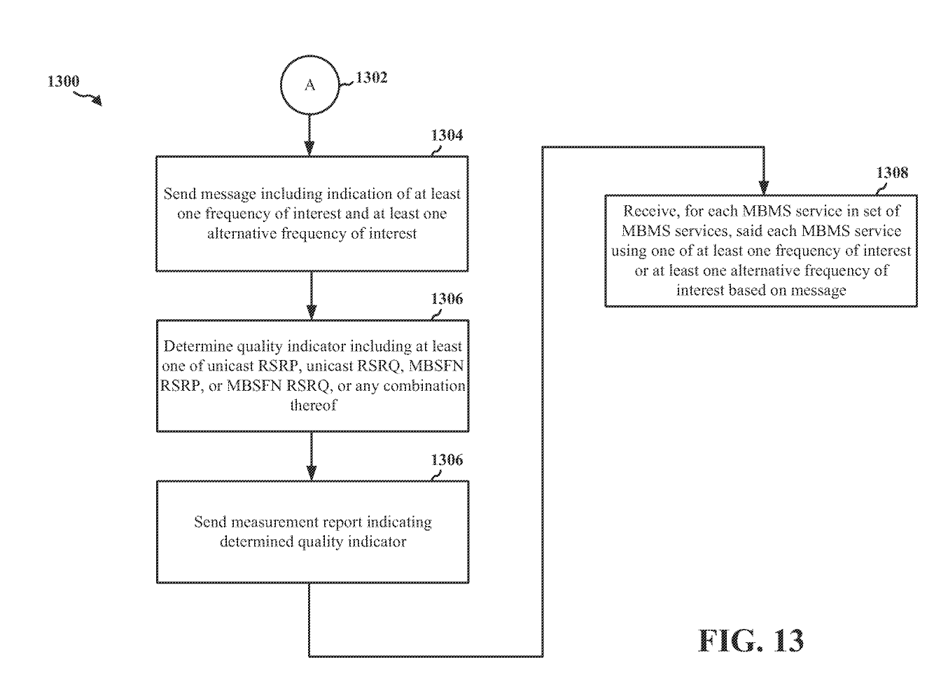

FIG. 13 is a flow chart 1300 of a method of wireless communication, expanding from the flow chart 1200 of FIG. 12A or the flow chart 1250 of FIG. 12B. The method may be performed by a UE (e.g., the UE 1002, the apparatus 1402/1402′). At 1302, the UE continues from 1208 of FIG. 12A or from 1254 of FIG. 12B. At 1304, the UE sends the message including an indication of at least one frequency of interest and at least one alternative frequency of interest. In an aspect, the at least one frequency of interest is used to provide a set of MBMS services and the at least one alternative frequency of interest is used to provide a subset of MBMS services of the set of MBMS services. In an aspect, the message is an MBMS interest indication message. At 1306, the UE may determine a quality indicator including at least one of a unicast RSRP, a unicast RSRQ, an MBSFN RSRP, or an MBSFN RSRQ, or any combination thereof. At 1306, the UE may send a measurement report indicating the determined quality indicator. At 1308, the UE receives, for each MBMS service in the set of MBMS services, said each MBMS service using one of the at least one frequency of interest or the at least one alternative frequency of interest based on the message. In an aspect, said one of the at least one frequency of interest or the at least one alternative frequency of interest on which said each MBMS service is received is based on the measurement report. In an aspect, said one of the at least one frequency of interest or the at least one alternative frequency of interest on which said each MBMS service is received is based on loading conditions on one or more base stations from which each MBMS service is received.

As discussed supra, the UE may generate and send an MBMS Interest Indication message to an eNB, where the MBMS Interest Indication message lists at least one main frequency in the main frequency list and at least one alternative frequency in the alternative frequency list or where the MBMS Interest Indication message lists at least one main frequency and at least one alternative frequency in the main frequency list. As discussed supra, when the eNB receives the MBMS Interest Indication message, then the eNB may determine the best frequency on which the UE may receive the MBMS service, among the frequencies listed the MBMS Interest Indication message, such that the UE may receive the MBMS service on the determined best frequency. As discussed supra, the eNB may determine the best frequency for the UE to receive the MBMS service based on metrics such as a loading condition and/or a measurement report from the UE. As discussed supra, for example, the UE may send the measurement report including the RSRP/RSRQ measurement of each frequency to the eNB, and subsequently, the eNB may determine that a frequency with the highest RSRP/RSRQ measurement is the best frequency based on the measurement report.

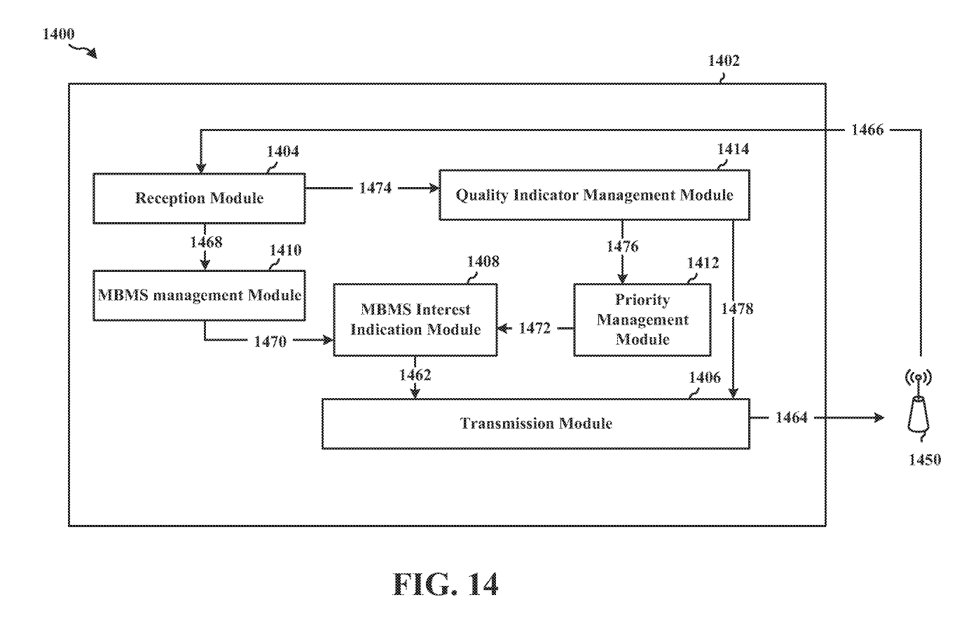

FIG. 14 is a conceptual data flow diagram 1400 illustrating the data flow between different modules/means/components in an exemplary apparatus 1402. The apparatus may be a UE. The apparatus includes a reception module 1404, a transmission module 1406, an MBMS Interest Indication module 1408, an MBMS management module 1410, a priority management module 1412, and a quality indicator module 1414.

The MBMS Interest Indication module 1408 sends via the transmission module 1406, at 1462 and at 1464, a message including an indication of at least one frequency of interest and at least one alternative frequency of interest. In an aspect, the at least one frequency of interest is used to provide a set of MBMS services and the at least one alternative frequency of interest is used to provide a subset of MBMS services of the set of MBMS services. The MBMS management module 1410 receives via the reception module 1404 at 1466 and at 1468, for each MBMS service in the set of MBMS services, said each MBMS service using one of the at least one frequency of interest or the at least one alternative frequency of interest based on the message. In an aspect, the message is an MBMS interest indication message. It is noted that the MBMS Interest Indication module 1408 may determine possible frequencies to list in the MBMS interest indication message based on information received from the MBMS management module 1410 via the reception module 1404 at 1466, 1468, and 1470.

In one aspect, the MBMS Interest Indication module 1408 generates the message to include a frequency list including the at least one frequency of interest, and to include an alternative frequency list including the at least one alternative frequency of interest. The priority management module 1412 determines a priority for each frequency associated with the at least one frequency of interest and the at least one alternative frequency of interest. In such an aspect, the frequency list includes at least one frequency for each MBMS service in the set of MBMS services with a highest determined priority, and the alternative frequency list includes at least one remaining frequency for each MBMS service in the subset of MBMS services, based on the priority information from the priority management module 1412 at 1472. In such an aspect, the alternative frequency list includes at least two alternative frequencies of interest in order of the determined priority. The quality indicator module 1414 determines a quality indicator including at least one of a unicast RSRP, a unicast RSRQ, an MBSFN RSRP, an MBSFN RSRQ, or any combination thereof, which may be based on signals received via the reception module 1404 at 1466 and 1474. The quality indicator module 1414 may provide the determined quality indicator to the priority management module 1412 at 1476. In such an aspect, the priority is determined by the priority management module 1412 based on the determined quality indicator. In another aspect, the MBMS Interest Indication module 1408 generates the message to include a frequency list including the at least one frequency of interest and the at least one alternative frequency of interest.

The quality indicator management module 1414 determines a quality indicator including at least one of a unicast RSRP, a unicast RSRQ, an MBSFN RSRP, or an MBSFN RSRQ, or any combination thereof. The quality indicator management module 1414 sends via the transmission module 1406 at 1478 and 1464 a measurement report indicating the determined quality indicator. In an aspect, said one of the at least one frequency of interest or the at least one alternative frequency of interest on which said each MBMS service is received at the MBMS management module 1410 via the reception module 1404 is based on the measurement report. In an aspect, said one of the at least one frequency of interest or the at least one alternative frequency of interest on which said each MBMS service is received is based on loading conditions on one or more base stations (e.g., the eNB 1450) from which each MBMS service is received.

The quality indicator management module 1414 determines a quality indicator including at least one of a unicast RSRP, a unicast RSRQ, an MBSFN RSRP, an MBSFN RSRQ, or any combination thereof, for each of multiple frequencies. In an aspect, the at least one frequency of interest includes one or more frequencies of the plurality of frequencies with a corresponding determined quality indicator greater than a threshold, and the at least one alternative frequency of interest includes one or more alternative frequencies of the plurality of frequencies with a corresponding determined quality indicator greater than the threshold.

The apparatus may include additional modules that perform each of the steps of the algorithm in the aforementioned flow charts of FIGS. 12A, 12B, and 13. As such, each step in the aforementioned flow charts of FIGS. 12A, 12B, and 13 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

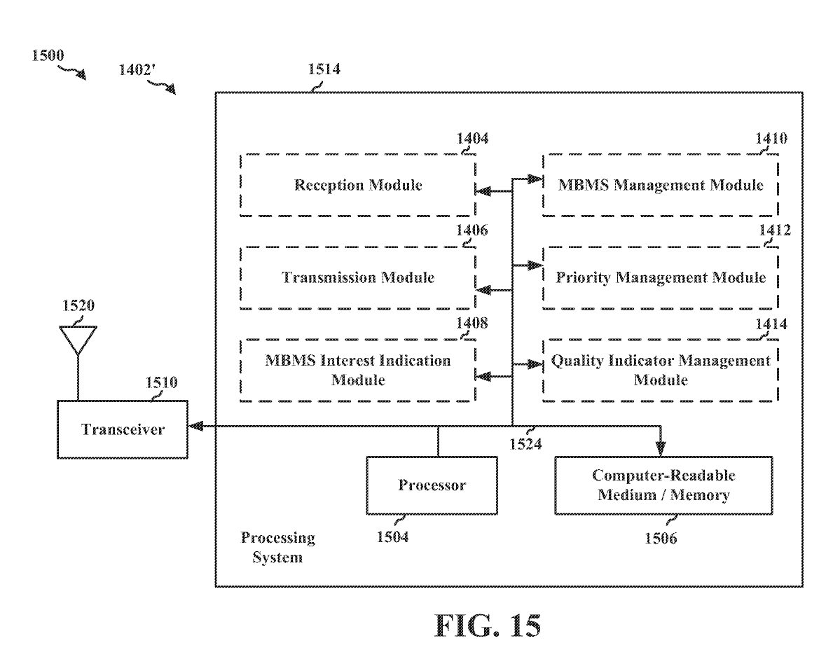

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware modules, represented by the processor 1504, the modules 1404, 1406, 1408, 1410, 1412, 1414, and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception module 1404. In addition, the transceiver 1510 receives information from the processing system 1514, specifically the transmission module 1406, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system further includes at least one of the modules 1404, 1406, 1408, 1410, 1412, and 1414. The modules may be software modules running in the processor 1504, resident/stored in the computer readable medium/memory 1506, one or more hardware modules coupled to the processor 1504, or some combination thereof. The processing system 1514 may be a component of the UE 650 and may include the memory 660 and/or at least one of the TX processor 668, the RX processor 656, and the controller/processor 659.

In one configuration, the apparatus 1402/1402′ for wireless communication includes means for sending a message including an indication of at least one frequency of interest and at least one alternative frequency of interest, where the at least one frequency of interest is used to provide a set of MBMS services and the at least one alternative frequency of interest is used to provide a subset of MBMS services of the set of MBMS services, and means for receiving, for each MBMS service in the set of MBMS services, said each MBMS service using one of the at least one frequency of interest or the at least one alternative frequency of interest based on the message. The apparatus 1402/1402′ further includes means for generating the message to include a frequency list including the at least one frequency of interest, and to include an alternative frequency list including the at least one alternative frequency of interest.

The apparatus 1402/1402′ further includes means for determining a priority for each frequency associated with the at least one frequency of interest and the at least one alternative frequency of interest. In an aspect, the frequency list includes at least one frequency for each MBMS service in the set of MBMS services with a highest determined priority, and the alternative frequency list includes at least one remaining frequency for each MBMS service in the subset of MBMS services. The apparatus 1402/1402′ further includes means for determining a quality indicator including at least one of a unicast RSRP, a unicast RSRQ, an MBSFN RSRP, an MBSFN RSRQ, or any combination thereof. In an aspect, the priority is determined based on the determined quality indicator. The apparatus 1402/1402′ further includes means for generating the message to include a frequency list including the at least one frequency of interest and the at least one alternative frequency of interest. The apparatus 1402/1402′ further includes means for determining a quality indicator including at least one of a unicast RSRP, a unicast RSRQ, an MBSFN RSRP, or an MBSFN RSRQ, or any combination thereof, and means for sending a measurement report indicating the determined quality indicator. In an aspect, said one of the at least one frequency of interest or the at least one alternative frequency of interest on which said each MBMS service is received is based on the measurement report. The aforementioned means may be one or more of the aforementioned modules of the apparatus 1402 and/or the processing system 1514 of the apparatus 1402′ configured to perform the functions recited by the aforementioned means. As described supra, the processing system 1514 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

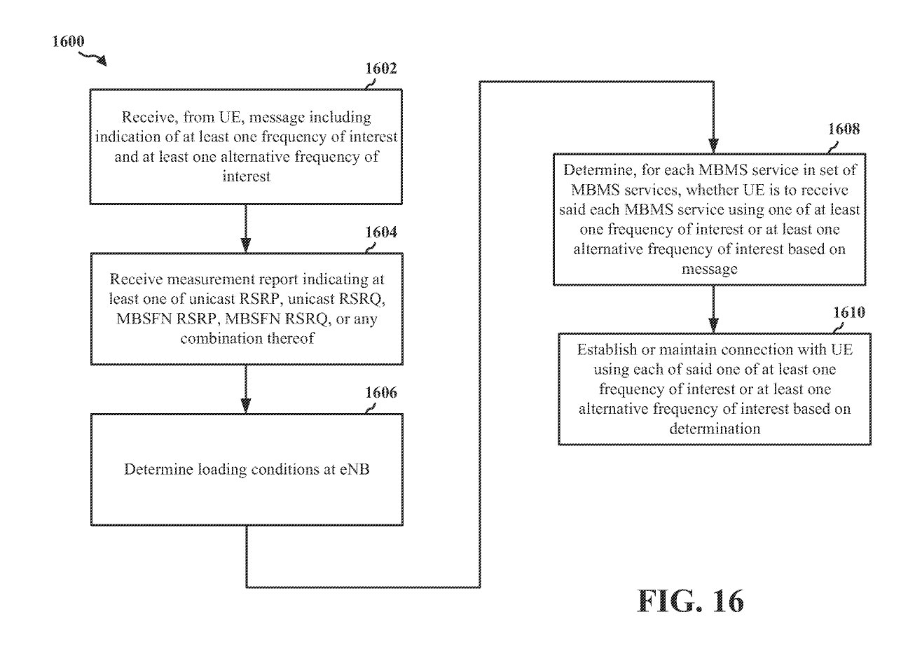

FIG. 16 is a flow chart 1600 of a method of wireless communication, according to an aspect of the disclosure. The method may be performed by an eNB (e.g., the eNB 1004, the apparatus 1702/1702′). At 1602, the eNB receives, from a UE, a message including an indication of at least one frequency of interest and at least one alternative frequency of interest. In an aspect, a set of MBMS services are provided on the at least one frequency of interest and a subset of MBMS services of the set of MBMS services are provided on the at least one alternative frequency of interest. In an aspect, establishing a connection with the UE using a particular frequency includes handing off the UE to the particular frequency. In an aspect, the message is an MBMS interest indication message.

In an aspect, the message includes a frequency list including the at least one frequency of interest, and includes an alternative frequency list including the at least one alternative frequency of interest. In an aspect, the base station prioritizes frequencies in the frequency list over frequencies in the alternative frequency list when determining whether the UE is to receive said each MBMS service using one of the at least one frequency of interest or the at least one alternative frequency of interest. In an aspect, the base station determines whether the UE is to receive a first frequency of the at least one alternative frequency of interest or a second frequency of the at least one alternative frequency of interest based on an order of the first frequency and the second frequency in the alternative frequency list. In another aspect, the message includes a frequency list including the at least one frequency of interest and the at least one alternative frequency of interest.

As discussed supra, the UE may generate and send an MBMS Interest Indication message to an eNB, where the MBMS Interest Indication message lists at least one main frequency in the main frequency list and at least one alternative frequency in the alternative frequency list or where the MBMS Interest Indication message lists at least one main frequency and at least one alternative frequency in the main frequency list. As discussed supra, when the eNB receives the MBMS Interest Indication message, then the eNB may determine the best frequency on which the UE may receive the MBMS service, among the frequencies listed the MBMS Interest Indication message, such that the UE may receive the MBMS service on the determined best frequency

At 1604, the eNB may receive a measurement report indicating at least one of a unicast RSRP, a unicast RSRQ, an MBSFN RSRP, an MBSFN RSRQ, or any combination thereof. At 1606, the eNB may determine loading conditions at the base station. At 1608, the eNB determines, for each MBMS service in the set of MBMS services, whether the UE is to receive said each MBMS service using one of the at least one frequency of interest or the at least one alternative frequency of interest based on the message. In an aspect, the determination of whether the UE is to receive said each MBMS service using one of the at least one frequency of interest or the at least one alternative frequency of interest is based on the measurement report. In an aspect, the determination of whether the UE is to receive said each MBMS service using one of the at least one frequency of interest or the at least one alternative frequency of interest is based on the determined loading conditions. In an aspect, the determination of whether the UE is to receive said each MBMS service using one of the at least one frequency of interest or the at least one alternative frequency of interest is further based on whether any one of the at least one alternative frequency of interest is being used to provide a same MBMS service as any one of the at least one frequency of interest. At 1610, the eNB establishes or maintains a connection with the UE using each of said one of the at least one frequency of interest or the at least one alternative frequency of interest based on the determination.

As discussed supra, when the eNB receives the MBMS Interest Indication message, then the eNB may determine the best frequency on which the UE may receive the MBMS service, among the frequencies listed the MBMS Interest Indication message, such that the UE may receive the MBMS service on the determined best frequency. As discussed supra, the eNB may determine the best frequency for the UE to receive the MBMS service based on metrics such as a loading condition and/or a measurement report from the UE. As discussed supra, for example, the UE may send the measurement report including the RSRP/RSRQ measurement of each frequency to the eNB, and subsequently, the eNB may determine that a frequency with the highest RSRP/RSRQ measurement is the best frequency based on the measurement report.

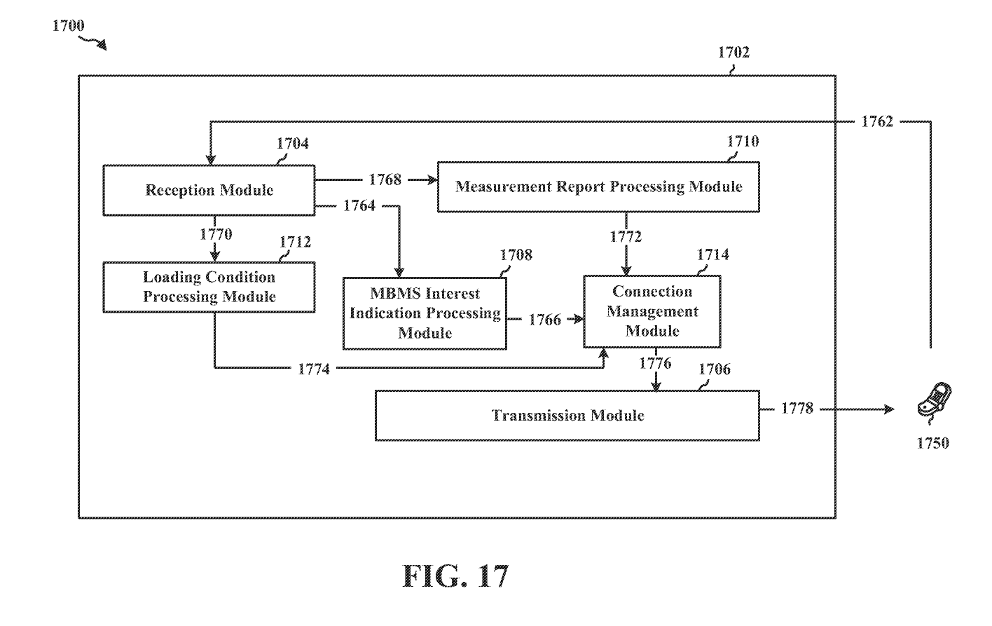

FIG. 17 is a conceptual data flow diagram 1700 illustrating the data flow between different modules/means/components in an exemplary apparatus 1702. The apparatus may be an eNB. The apparatus includes a reception module 1704, a transmission module 1706, an MBMS Interest Indication processing module 1708, a measurement report processing module 1710, a loading condition processing module 1712, and a connection management module 1714.

The MBMS Interest Indication processing module 1708 receives via the reception module 1704 at 1762 and 1764, from a UE 1750, a message including an indication of at least one frequency of interest and at least one alternative frequency of interest. In an aspect, a set of MBMS services are provided on the at least one frequency of interest and a subset of MBMS services of the set of MBMS services are provided on the at least one alternative frequency of interest. In an aspect, the message is an MBMS interest indication message.

In an aspect, the message includes a frequency list including the at least one frequency of interest, and includes an alternative frequency list including the at least one alternative frequency of interest. In an aspect, the MBMS Interest Indication processing module 1708 prioritizes frequencies in the frequency list over frequencies in the alternative frequency list when determining via the connection management module 1714 whether the UE is to receive said each MBMS service using one of the at least one frequency of interest or the at least one alternative frequency of interest. In an aspect, the connection management module 1714 determines whether the UE is to receive a first frequency of the at least one alternative frequency of interest or a second frequency of the at least one alternative frequency of interest based on an order of the first frequency and the second frequency in the alternative frequency list, according to information received from the MBMS Interest Indication processing module 1708 at 1766. In an aspect, the message may include a frequency list including the at least one frequency of interest and the at least one alternative frequency of interest.

The measurement report processing module 1710 may receive via the reception module 1704 at 1762 and 1768 a measurement report indicating at least one of a unicast RSRP, a unicast RSRQ, an MBSFN RSRP, an MBSFN RSRQ, or any combination thereof. The loading condition processing module 1712 may determine loading conditions at the eNB 1702, based on information received via the reception module 1704 at 1762 and 1770. The connection management module 1714 determines, for each MBMS service in the set of MBMS services, whether the UE 1750 is to receive said each MBMS service using one of the at least one frequency of interest or the at least one alternative frequency of interest based on the message, based on information received from the MBMS Interest Indication processing module 1708 at 1766. In an aspect, the determination by the connection management module 1714 of whether the UE 1750 is to receive said each MBMS service using one of the at least one frequency of interest or the at least one alternative frequency of interest is based on the measurement report received from the measurement report processing module 1710 at 1772. In an aspect, the determination by the connection management module 1714 of whether the UE 1750 is to receive said each MBMS service using one of the at least one frequency of interest or the at least one alternative frequency of interest is based on the determined loading conditions that is received from the loading condition processing module 1712 at 1774. In an aspect, the determination of whether the UE 1750 is to receive said each MBMS service using one of the at least one frequency of interest or the at least one alternative frequency of interest is further based on whether any one of the at least one alternative frequency of interest is being used to provide a same MBMS service as any one of the at least one frequency of interest. The connection management module 1714 establishes or maintains a connection with the UE 1750 using each of said one of the at least one frequency of interest or the at least one alternative frequency of interest based on the determination, via the transmission module 1706 at 1776 and 1778. In an aspect, establishing a connection with the UE 1750 using a particular frequency includes handing off the UE 1750 to the particular frequency.

The apparatus may include additional modules that perform each of the steps of the algorithm in the aforementioned flow charts of FIG. 16. As such, each step in the aforementioned flow charts of FIG. 16 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

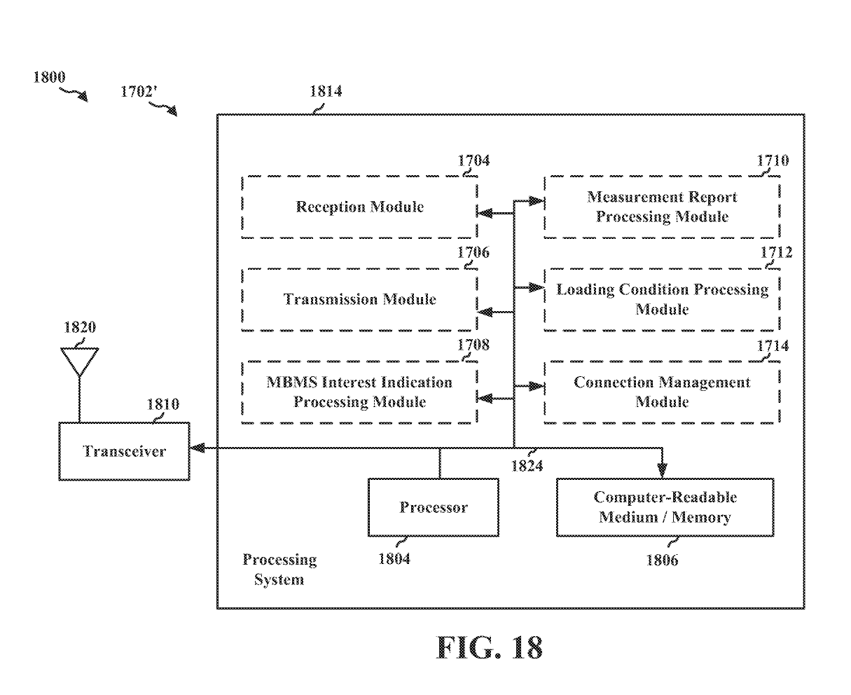

FIG. 18 is a diagram 1800 illustrating an example of a hardware implementation for an apparatus 1702′ employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware modules, represented by the processor 1804, the modules 1704, 1706, 1708, 1710, 1712, 1714, and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814, specifically the reception module 1704. In addition, the transceiver 1810 receives information from the processing system 1814, specifically the transmission module 1706, and based on the received information, generates a signal to be applied to the one or more antennas 1820. The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system further includes at least one of the modules 1704, 1706, 1708, 1710, 1712, and 1714. The modules may be software modules running in the processor 1804, resident/stored in the computer readable medium/memory 1806, one or more hardware modules coupled to the processor 1804, or some combination thereof. The processing system 1814 may be a component of the eNB 610 and may include the memory 676 and/or at least one of the TX processor 616, the RX processor 670, and the controller/processor 675.

In one configuration, the apparatus 1702/1702′ for wireless communication includes means for receiving, from a UE, a message including an indication of at least one frequency of interest and at least one alternative frequency of interest, where a set of MBMS services are provided on the at least one frequency of interest and a subset of MBMS services of the set of MBMS services are provided on the at least one alternative frequency of interest, means for determining, for each MBMS service in the set of MBMS services, whether the UE is to receive said each MBMS service using one of the at least one frequency of interest or the at least one alternative frequency of interest based on the message, and means for establishing or maintaining a connection with the UE using each of said one of the at least one frequency of interest or the at least one alternative frequency of interest based on the determination. The apparatus 1702/1702′ further includes means for receiving a measurement report indicating at least one of a unicast RSRP, a unicast RSRQ, an MBSFN RSRP, an MBSFN RSRQ, or any combination thereof. In an aspect, the determination of whether the UE is to receive said each MBMS service using one of the at least one frequency of interest or the at least one alternative frequency of interest is based on the measurement report. The apparatus 1702/1702′ further includes means for determining loading conditions at the apparatus 1702/1702′. In an aspect, the determination of whether the UE is to receive said each MBMS service using one of the at least one frequency of interest or the at least one alternative frequency of interest is based on the determined loading conditions. The aforementioned means may be one or more of the aforementioned modules of the apparatus 1702 and/or the processing system 1814 of the apparatus 1702′ configured to perform the functions recited by the aforementioned means. As described supra, the processing system 1814 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
sending a message including an indication of at least one frequency of interest and at least one alternative frequency of interest, wherein the at least one frequency of interest is used to provide a set of multimedia broadcast multicast service (MBMS) services and the at least one alternative frequency of interest is used to provide a subset of MBMS services of the set of MBMS services; and
receiving, for each MBMS service in the set of MBMS services, said each MBMS service using one of the at least one frequency of interest or the at least one alternative frequency of interest based on the message.

2. The method of claim 1, wherein the message is an MBMS interest indication message.

3. The method of claim 1, further comprising generating the message to include a frequency list including the at least one frequency of interest, and to include an alternative frequency list including the at least one alternative frequency of interest.

4. The method of claim 3, further comprising determining a priority for each frequency associated with the at least one frequency of interest and the at least one alternative frequency of interest, wherein the frequency list includes at least one frequency for each MBMS service in the set of MBMS services with a highest determined priority, and the alternative frequency list includes at least one remaining frequency for each MBMS service in the subset of MBMS services.

5. The method of claim 4, wherein the alternative frequency list includes at least two alternative frequencies of interest in order of the determined priority.

6. The method of claim 4, further comprising determining a quality indicator including at least one of a unicast reference signal received signal power (RSRP), a unicast reference signal received signal quality (RSRQ), a multicast broadcast single frequency network (MBSFN) RSRP, an MBSFN RSRQ, or any combination thereof, wherein the priority is determined based on the determined quality indicator.

7. The method of claim 1, further comprising generating the message to include a frequency list including the at least one frequency of interest and the at least one alternative frequency of interest.

8. The method of claim 1, further comprising:
determining a quality indicator including at least one of a unicast reference signal received signal power (RSRP), a unicast reference signal received signal quality (RSRQ), a multicast broadcast single frequency network (MBSFN) RSRP, or an MBSFN RSRQ, or any combination thereof; and
sending a measurement report indicating the determined quality indicator,
wherein said one of the at least one frequency of interest or the at least one alternative frequency of interest on which said each MBMS service is received is based on the measurement report.

9. The method of claim 1, wherein said one of the at least one frequency of interest or the at least one alternative frequency of interest on which said each MBMS service is received is based on loading conditions on one or more base stations from which each MBMS service is received.

10. The method of claim 1, further comprising:
determining a quality indicator including at least one of a unicast reference signal received signal power (RSRP), a unicast reference signal received signal quality (RSRQ), a multicast broadcast single frequency network (MBSFN) RSRP, an MBSFN RSRQ, or any combination thereof, for each of a plurality of frequencies,
wherein the at least one frequency of interest includes one or more frequencies of the plurality of frequencies with a corresponding determined quality indicator greater than a threshold, and the at least one alternative frequency of interest includes one or more alternative frequencies of the plurality of frequencies with a corresponding determined quality indicator greater than the threshold.

11. An apparatus for wireless communication, comprising:
a memory; and
at least one processor coupled to the memory and configured to:
send a message including an indication of at least one frequency of interest and at least one alternative frequency of interest, wherein the at least one frequency of interest is used to provide a set of multimedia broadcast multicast service (MBMS) services and the at least one alternative frequency of interest is used to provide a subset of MBMS services of the set of MBMS services; and
receive, for each MBMS service in the set of MBMS services, said each MBMS service using one of the at least one frequency of interest or the at least one alternative frequency of interest based on the message.

12. The apparatus of claim 11, wherein the message is an MBMS interest indication message.

13. The apparatus of claim 11, wherein the at least one processor is further configured to generate the message to include a frequency list including the at least one frequency of interest, and to include an alternative frequency list including the at least one alternative frequency of interest.

14. The apparatus of claim 13, wherein the at least one processor is further configured to determine a priority for each frequency associated with the at least one frequency of interest and the at least one alternative frequency of interest, wherein the frequency list includes at least one frequency for each MBMS service in the set of MBMS services with a highest determined priority, and the alternative frequency list includes at least one remaining frequency for each MBMS service in the subset of MBMS services.

15. The apparatus of claim 14, wherein the alternative frequency list includes at least two alternative frequencies of interest in order of the determined priority.

16. The apparatus of claim 14, wherein the at least one processor is further configured to determine a quality indicator including at least one of a unicast reference signal received signal power (RSRP), a unicast reference signal received signal quality (RSRQ), a multicast broadcast single frequency network (MBSFN) RSRP, an MBSFN RSRQ, or any combination thereof, wherein the priority is determined based on the determined quality indicator.

17. The apparatus of claim 11, wherein the at least one processor is further configured to generate the message to include a frequency list including the at least one frequency of interest and the at least one alternative frequency of interest.

18. The apparatus of claim 11, wherein the at least one processor is further configured to:
determine a quality indicator including at least one of a unicast reference signal received signal power (RSRP), a unicast reference signal received signal quality (RSRQ), a multicast broadcast single frequency network (MBSFN) RSRP, or an MBSFN RSRQ, or any combination thereof; and
send a measurement report indicating the determined quality indicator,
wherein said one of the at least one frequency of interest or the at least one alternative frequency of interest on which said each MBMS service is received is based on the measurement report.

19. The apparatus of claim 11, wherein said one of the at least one frequency of interest or the at least one alternative frequency of interest on which said each MBMS service is received is based on loading conditions on one or more base stations from which each MBMS service is received.

20. The apparatus of claim 11, wherein the at least one processor is further configured to:
determine a quality indicator including at least one of a unicast reference signal received signal power (RSRP), a unicast reference signal received signal quality (RSRQ), a multicast broadcast single frequency network (MBSFN) RSRP, an MBSFN RSRQ, or any combination thereof, for each of a plurality of frequencies,
wherein the at least one frequency of interest includes one or more frequencies of the plurality of frequencies with a corresponding determined quality indicator greater than a threshold, and the at least one alternative frequency of interest includes one or more alternative frequencies of the plurality of frequencies with a corresponding determined quality indicator greater than the threshold.

21. An apparatus for wireless communication, comprising:
means for sending a message including an indication of at least one frequency of interest and at least one alternative frequency of interest, wherein the at least one frequency of interest is used to provide a set of multimedia broadcast multicast service (MBMS) services and the at least one alternative frequency of interest is used to provide a subset of MBMS services of the set of MBMS services; and
means for receiving, for each MBMS service in the set of MBMS services, said each MBMS service using one of the at least one frequency of interest or the at least one alternative frequency of interest based on the message.

22. The apparatus of claim 21, further comprising means for generating the message to include a frequency list including the at least one frequency of interest, and to include an alternative frequency list including the at least one alternative frequency of interest.

23. The apparatus of claim 22, further comprising means for determining a priority for each frequency associated with the at least one frequency of interest and the at least one alternative frequency of interest, wherein the frequency list includes at least one frequency for each MBMS service in the set of MBMS services with a highest determined priority, and the alternative frequency list includes at least one remaining frequency for each MBMS service in the subset of MBMS services.

24. The apparatus of claim 23, wherein the alternative frequency list includes at least two alternative frequencies of interest in order of the determined priority.

25. The apparatus of claim 23, further comprising means for determining a quality indicator including at least one of a unicast reference signal received signal power (RSRP), a unicast reference signal received signal quality (RSRQ), a multicast broadcast single frequency network (MBSFN) RSRP, an MBSFN RSRQ, or any combination thereof, wherein the priority is determined based on the determined quality indicator.

26. The apparatus of claim 21, further comprising means for generating the message to include a frequency list including the at least one frequency of interest and the at least one alternative frequency of interest.

27. The apparatus of claim 21, further comprising:
means for determining a quality indicator including at least one of a unicast reference signal received signal power (RSRP), a unicast reference signal received signal quality (RSRQ), a multicast broadcast single frequency network (MBSFN) RSRP, or an MBSFN RSRQ, or any combination thereof; and
means for sending a measurement report indicating the determined quality indicator,
wherein said one of the at least one frequency of interest or the at least one alternative frequency of interest on which said each MBMS service is received is based on the measurement report.

28. The apparatus of claim 21, wherein said one of the at least one frequency of interest or the at least one alternative frequency of interest on which said each MBMS service is received is based on loading conditions on one or more base stations from which each MBMS service is received.

29. The apparatus of claim 21, further comprising:
means for determining a quality indicator including at least one of a unicast reference signal received signal power (RSRP), a unicast reference signal received signal quality (RSRQ), a multicast broadcast single frequency network (MBSFN) RSRP, an MBSFN RSRQ, or any combination thereof, for each of a plurality of frequencies,
wherein the at least one frequency of interest includes one or more frequencies of the plurality of frequencies with a corresponding determined quality indicator greater than a threshold, and the at least one alternative frequency of interest includes one or more alternative frequencies of the plurality of frequencies with a corresponding determined quality indicator greater than the threshold.

30. A computer program product stored on a computer-readable medium and comprising code that when executed on at least one processor causes the at least one processor to:
send a message including an indication of at least one frequency of interest and at least one alternative frequency of interest, wherein the at least one frequency of interest is used to provide a set of multimedia broadcast multicast service (MBMS) services and the at least one alternative frequency of interest is used to provide a subset of MBMS services of the set of MBMS services; and
receive, for each MBMS service in the set of MBMS services, said each MBMS service using one of the at least one frequency of interest or the at least one alternative frequency of interest based on the message.
